(19) United States
(12) Patent Application Publication
(10) Pub. No.: US 2003/0077561 A1
(43) Pub. Date: Apr. 24, 2003

(54) Web server for printable whiteboards

(76) Inventors: Abraham Alsop, Boise, ID (US); Joel R. Fyan, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/982,596

(22) Filed: Oct. 18, 2001

(51) Int. Cl. B43L 1/00

(52) U.S. Cl. 434/408

(57) ABSTRACT

The present invention includes a system for and a method of operating an electronic whiteboard having a drawing medium, an input device, a server and a communications interface. The input device is configured to image a writing made on the drawing medium and provide an electronic representation of the writing to the server which formats the electronic representation into a hypertext transport protocol. This hypertext transport protocol is used to transmit displayed data to a remote location.

### RELATED APPLICATIONS

The present application is related to previously filed, commonly assigned U.S. patent application Ser. No. 09/687,795 filed Oct. 12, 2000, entitled “SYSTEM FOR AND METHOD OF CONDUCTING LARGE AUDIENCE COLLABORATIVE CONFERENCE MEETINGS AT MULTIPLE LOCATIONS SIMULTANEOUSLY,” the disclosure of which is hereby incorporated herein by reference.

### TECHNICAL FIELD

The present invention is related to the transfer of data from whiteboards to processor-driven devices.

### BACKGROUND

Generally there are three types of whiteboards. The first is a stand-alone device which is used much as a chalkboard would be used. An individual writes on the whiteboard with erasable markers and, afterwards, the words, diagrams, or symbols, etc. are erased from the surface of the whiteboard.

The second type of whiteboard combines a printing capability by including scanning device with the stand-alone whiteboard. This capability allows a presenter or another individual the ability to print a hard copy of the presentation, i.e., words, diagrams, symbols, etc. displayed on the whiteboard. One embodiment of this type of whiteboard allows the user to press a print button that causes the surface containing the writing to be transported by peripheral rollers past an optical scanning device. The surface is scanned as it passes the optical scanner to create an output or hard copy of information displayed on that whiteboard. Alternatively, the surface of the whiteboard may remain stationary, the optical scanning device is then transported across the stationary surface on motorized tracks.

A third type of whiteboard includes an interface to a Personal Computer (PC). One example of this type of whiteboard is manufactured by IBID. In this configuration, the user may select colors for the writings from a palette of available colors. For instance, if the user selects the blue color, writing on the whiteboard will be displayed in blue on the computer display. In this configuration, the whiteboard is connected to a PC and transmits both the selected colors and information associated with the writing on the surface. This information can be stored on the PC in an electronic file.

Certain applications and utilities provide for enhanced compatibility and ease of connection between and among systems and applications. For example, JETSEND® by HEWLETT PACKARD® and BLUETOOTH® both support the transmission of images and pictures in a manner that is device independent and may be used between numerous types of computer devices. These and equivalent connections may be used to transmit images between a whiteboard, printer, computer, and/or a scanner without changing the image format. JETSEND® may be preferred to the extent that it includes encoding data to support the transmission of the data over dedicated and networked wires, wireless connections and over phone lines.

However, in spite of these improvements, limited advances have been made to provide for remote conferencing of facilities typically supporting only group presentations. Accordingly, a need exists for a method of and a system for extending conferencing facilities to remote participants.

### SUMMARY OF THE INVENTION

The present invention is directed to a remote conferencing system which includes an electronic whiteboard system having a drawing medium, an input device, a server and a communications interface. The input device is configured to image a writing made on the drawing medium and to provide an electronic representation of the writing into a hypertext transport protocol. The communications interface of the present invention is configured to transmit the electronic representation to a remote location.

The present invention also includes a method of conducting a remote conference which includes the steps of positioning a viewable medium to be viewed by a first plurality of conference participants and receiving a first image from a remote location. The received first image is displayed on the viewable medium and a second image can be manually written on the viewable medium. The second image is converted to an electronic format which is combined with the first image to form a combined image which is transmitted and displayed at the remote location to a second plurality of conference participants.

### BRIEF DESCRIPTION OF THE DRAWINGS

FIG. 1 is a diagram depicting one embodiment of the present invention;

FIG. 2 is a diagram depicting one implementation of the present invention;

FIG. 3 is a flow chart of actions performed on the whiteboard of the present invention; and

FIG. 4 is a flow chart of actions performed in the remote participant portion of the present invention.

### DETAILED DESCRIPTION

FIG. 1 depicts a meeting or conference site 100 including a group viewable, electronic whiteboard 101 and associated equipment interfacing to a client supporting a remotely located conference participant. Whiteboard 101 may be configured in a number of ways to display a presentation to local conference participants. For example, whiteboard 101 may provide a writing surface, overlay, or drawing medium onto which a user may write and draw using dry erasable markers of various types and colors. Whiteboard 101 may further include a peripheral printer for electronically generating printed material onto the surface or overlay. In addition, an electronic display (e.g., LCD) may be incorporated into the structure or a video projector system may be used to project an image onto whiteboard 101 (e.g., front or rear projection).

Information displayed on whiteboard 101 is read and processed at specific time intervals by a processor (not shown) or other input device whose information is sent to server 104. While this process may be initiated by a user, this processing typically occurs automatically without user intervention. The processor may also be configured to process information displayed on whiteboard 101 continuously in order to provide near real-time time communication. Web server 104 saves information displayed on whiteboard 101 in one or more suitable file formats, such as JPEG, GIF, bitmap and/or ASCII files. The first two of these file formats are popular Internet file picture formats so that the saved file, in this configuration, is compatible with web server 104. Web server 104 may be configured to regularly, or as needed, overwrite the previous files residing on the web server with updated information. This configuration enables a user browsing the location or uniform resource locator (URL) to receive the current content without accessing a new URL. A database 107 may be included as part of or separate from web server platform 108 to store a plurality of web pages including the electronic representation of writings in whiteboard 101. A remote participant at remote location 106 would therefore see the most current updated image. In one configuration, web server 104 supplies information to a client on request while according to another configuration, web server 104 automatically pushes the saved file to the remote participant's computer. The server may also include a hypertext transport protocol daemon configured to handle requests from the remote location.

In another embodiment of the present invention, the user at whiteboard 101 manually, automatically and/or periodically initiates a software process that refreshes the display.

The software used to update the remote locations' 106 screen may be a plug-in to an existing browser or a standalone application. For example, a plug-in to Netscape or a plug-in to Internet Explorer could be configured to communicate and refresh in such a way that the participant is able to participate in the meeting.

In a preferred embodiment support for live or recorded video material may be provided by a suitable helper or plug-in, e.g., a REALVIDEO® player may incorporate streaming video to update remote screen 106.

Depending on the application, the remote participant may want to refresh the remote screen 106 every few minutes or nearly continuously. One skilled in the art would appreciate that the required refresh rate impacts the bandwidth required for the connection between server 104 and the remote computer. In a preferred embodiment an internet 105 or other communication interface provides connectivity between the locations.

A preferred embodiment may include the ability of the system to identify the frequency of changes on or updates made to the data displayed on whiteboard 101. As the number and extent of the changes increase, the updated information may be sent more frequently to remote participants. One embodiment of the present invention includes a selectable refresh rate at the remote participant's location to control the bandwidth of the connection or the frequency of updating.

Referring again to FIG. 1, microphone 102 may be used to transmit the voices of participants to the remote participants. Thus, in addition to graphics and text displayed on whiteboard 101, a remote participant at remote screen 106 may hear live audio from microphone 102 (or other audio sources) during conferences. One method of providing the audio communication is existing streaming audio protocols, for example, REALAUDIO®.

Controls 103 may include a print screen, clear, and a server connection on-off capability. Selection of the print button provides a hard copy of whiteboard 101 to the local user. In one implementation, a printer may be connected to the server and the print button may be used to initiate a print operation. Alternatively, JETSEND® or similar device-to-device communications technology may be used and whiteboard 101 may send data directly to a printer.

In one embodiment of the present invention, whiteboard 101 may include a selectable e-mail button. Associated with the e-mail button may be a list of e-mail addresses stored on or available to the server identifying recipients of information displayed on whiteboard 101. By pressing the e-mail button and selecting a distribution list of one or more recipients, information displayed on whiteboard 101 may be sent to individuals included in the distribution list. This capability may be used to keep members of a team or a class informed of information presented or exchanged during meetings held during their absence. Additionally, this feature may be used to provide participants with related or coordinating information. For instance, “we're starting now” may be written on whiteboard 101 and e-mail may be selected to notify participants of the start of a presentation.

Multiple distribution lists may be accessible from whiteboard 101 through server 104 or a distribution list may be accessed via the input/output features of web server 104. For instance, a diskette containing a distribution list may be accessed via web server 104.

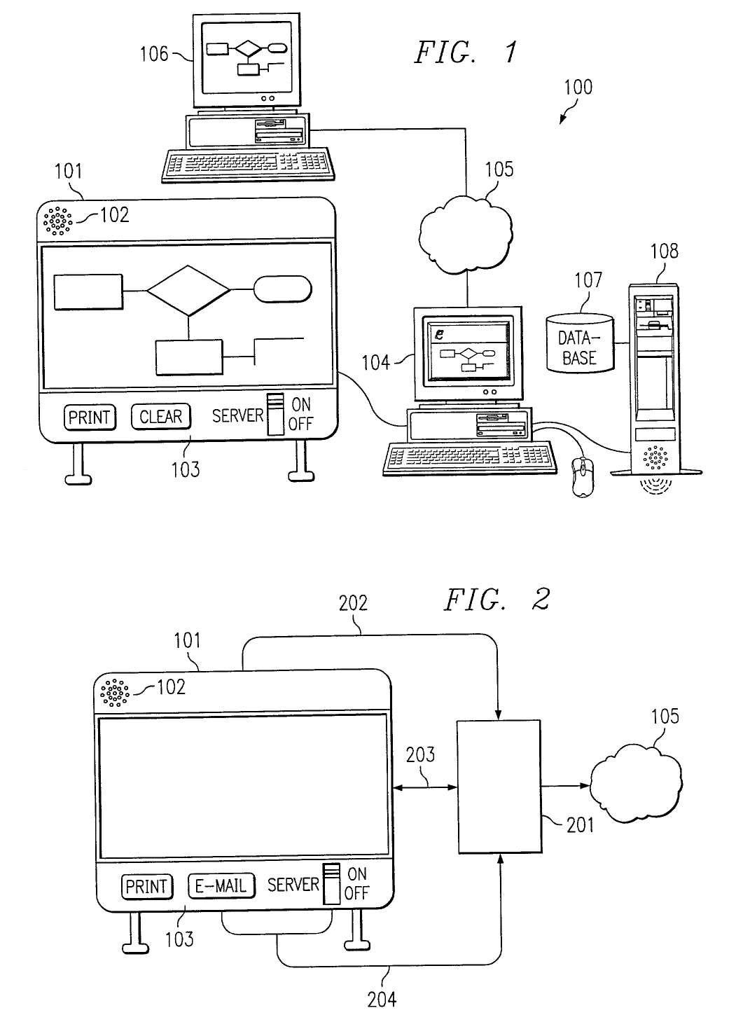

FIG. 2 illustrates one implementation of a whiteboard/server system according to the instant invention. Whiteboard 101 is connected to personal computer (PC) 201 for the transmission of, for example, three different signals. A first signal representing audio from microphone 102 may be connected via connection 202 to PC 201. Additionally, graphic and text information displayed on whiteboard 101 may be transmitted, preferably in a JETSEND® format, via connection 203 to PC 201. A customized connection 204 may communicate control signals and selections from controls 103 of whiteboard 101 to PC 201. This connection may ensure user selection of various controls are transmitted and properly interpreted in PC 201. Signal 203 provides a bi-directional path for the transmission of displayed data from whiteboard 101 to PC 201 and graphics and text to be displayed from PC 201 to whiteboard 101. PC 201 receives the audio information, the information displayed on whiteboard 101, and information concerning selections of controls via the three connections previously described. PC 201 may include JETSEND® software and web server software. Alternatively, PC 201 may be connected to a separate web server for access to an intranet or internet. In one embodiment, PC 201 may include a LAN card to connect to internet 105. Signals representing audio from microphone 102 and signals representing information displayed on whiteboard 101 received via connections 202 and 203, may be transmitted via PC 201 to internet 105. Note that, although three separate signal paths are shown for purposes of illustration, these signal paths may be combined into fewer physical connections and paths using conventional signal transmission technology and techniques. Similarly, the communications interface between whiteboard 101 and PC 201 may include further functionality including, for example, transfer of video images to PC 201 from a whiteboard mounted video camera or from PC 201 to whiteboard 101 for display thereon. Another example is remote control of whiteboard functionality by PC 201 by appropriate signaling to whiteboard 101.

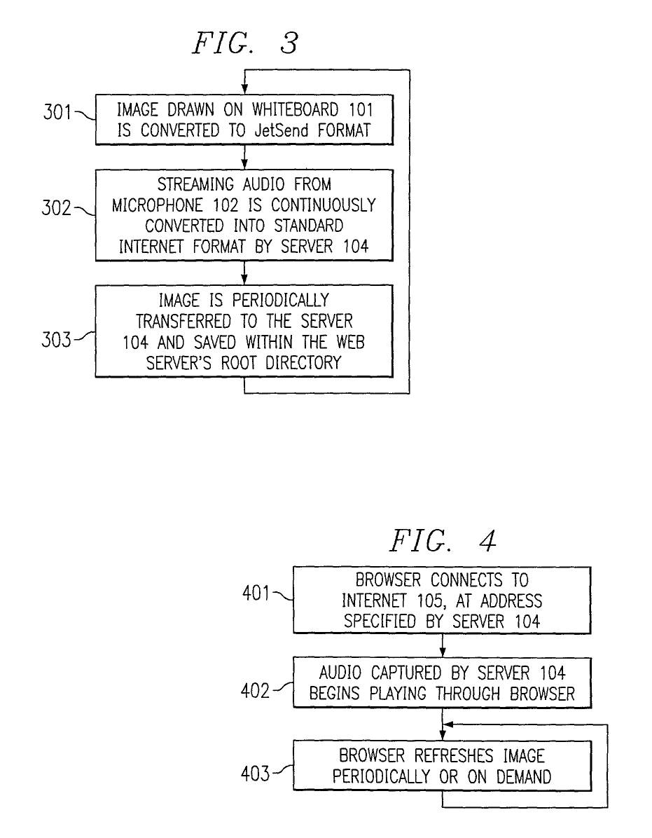

FIG. 3 illustrates a flow chart of a method of operating whiteboard 101. In step 301, an image drawn on the whiteboard is captured and converted into an appropriate electronic format. The image may be converted to an image format, such as a bitmap file (BMP), JPEG, GIF, PDF or the like. The image my also be converted to a text format using optical character recognition (OCR) to identify text. The text could then be stored as an ASCII or other text file format. These formats may be supported by, for example, Hypertext Mark-up Language (HTML). One of ordinary skill in the art would also understand that other file formats, such as geometric, alphanumeric, Portable Network Graphics (PNG), Computer Graphics Metafile (CGM), Group 3 Facsimile, Graphics Interchange Format (GIF), JPEG File Interchange Format, Tag Image File Format (TIFF), MPEG, CCITT H.261 encoded image data and the like.

The resultant files are then converted to an appropriate format for transmission, such as a BLUETOOTH® or JETSEND® format. In step 302, audio from microphone 102 of whiteboard 101 may be converted into a standard Internet format by server 104 of FIG. 1 or PC 201 of FIG. 2. In step 303, the image displayed on whiteboard 101 may be periodically transferred to server 104 of FIG. 1 or PC 201 of FIG. 2 and may be saved within the web root directory of the receiving device. Steps 301, 302, and 303 may be repeatedly performed during the conference to update remote clients. The periodic transference of images displayed on whiteboard 101 to the receiving device may be initiated by the user of whiteboard 101, by a processor which identifies when changes have been made to the display of whiteboard 101, at the direction of a user at a remote location, or with sufficient frequency enough to maintain a near real-time display of the data on whiteboard 101 at the remote location.

FIG. 4 illustrates a flow chart of the actions which may be performed by a participant at a remote location according to the present invention. Initially, at step 401, the remote user may connect via a browser in association with remote screen 106 to, for example, internet 105 using an address specified by server 104. This address may be a URL. In step 402, audio captured by microphone 102 at whiteboard 101 may be sent by server 104 of FIG. 1 or PC 201 of FIG. 2 over the internet 105 and made available to one or more remote participants using an appropriate plug-in installed in browser 106. In step 403, the browser may refresh the image periodically or on demand on remote screen 106. The image on remote screen 106 may be updated via the methods previously described. A browser may be used to display this image.

The present invention may be embodied in a system such as a remote conferencing system that has an electronic whiteboard system. The electronic whiteboard has a drawing medium, surface or screen and an input device that is configured to image any writing made on the drawing medium, surface or screen. The input device generates an electronic representation of the writing, such as an electronic data file having a text or graphic file format. The input device may include an image data compressor. The input device may also include a format converter that is configured to convert image data between two different image formats, at least one of said formats including one of raster, bitmapped, geometric, alphanumeric, Portable Network Graphics (PNG), Computer Graphics Metafile (CGM), Group 3 Facsimile, Graphics Interchange Format (GIF), JPEG File Interchange Format, Tag Image File Format (TIFF), MPEG, CCITT H.261 encoded image data and the like.

Preferably, a server is configured to format the electronic representation of the writing, or data file, into a hypertext transport protocol. The electronic whiteboard also includes a communications interface that is configured to transmit the electronic representation, or data file, to a remote location, such as a remote conferencing center.

The server may include a hypertext transport protocol daemon that is configured to handle requests from the remote location. The server may also include a database for storing a plurality of web pages or web page addresses. The web pages preferably include the electronic representation of the writing. Each of the web pages is addressable by a uniform resource locator (URL). The server is configured to broadcast the electronic representation of the white board writing to a plurality of clients.

In one embodiment, the remote conferencing system may also include an auxiliary input channel configured to receive a second input source. The second input source may be an audio input device, such as a microphone. The second input source may also include a video input device.

In a preferred embodiment, the drawing medium, screen or surface has a dynamic graphical input device that is configured to detect drawings or writings that are made on the drawing medium in near real-time. The remote conferencing system according to claim 1 wherein said input device includes an image data compressor.

The remote conferencing system may be used to conduct a remote conference by positioning a viewable medium, such as a whiteboard, viewing screen or other surface, that can be viewed by a first group of conference participants at a first location. When the conferencing system receives an image from a remote location, the first image is displayed on the viewable medium. A conference participant can write a second image onto the viewable medium. This second image is then converted by the system into an electronic format, such as a JPEG, GIF, TIFF or other electronic text or image file format. The second image may be converted by optically scanning the second image to provide a digital image signal.

The first and second images are then combined by the system to form a composite image. This combining may be done at the viewable medium, such as at a whiteboard, or at a local server. The composite image is then transmitted to the remote location and displayed to a second group of conference participants at the remote location. The image conversion may be triggered in response to a color of the first image for selectively processing the second image as one of text and graphics.

A participant at the remote location may then manually write or draw, at the remote location, a third image onto the composite image to form a new composite image. This new composite image, which may include elements of the first, second and third images, is then captured, converted and transmitted to the first location, where the new composite image may be viewed by the first group of conference participants. The new composite image is displayed to said first plurality of conference participants on the viewable medium or surface.

What is claimed is:

1. A remote conferencing system comprising:
an electronic whiteboard system having
a drawing medium;
an input device configured to image a writing made on said drawing medium to provide an electronic representation of the writing;
a server configured to format said electronic representation of the writing into a hypertext transport protocol; and
a communications interface configured to transmit said electronic representation to a remote location.

2. The remote conferencing system according to claim 1 wherein said server includes a hypertext transport protocol daemon configured to handle requests from said remote location.

3. The remote conferencing system according to claim 1 wherein said server includes a database storing a plurality of web pages including said electronic representation of said writing, each of said web pages addressable by a respective uniform resource locator.

4. The remote conferencing system according to claim 1 wherein said server is configured to broadcast said electronic representation to a plurality of clients.

5. The remote conferencing system according to claim 1 further including;
an auxiliary input channel configured to receive a second input source.

6. The remote conferencing system according to claim 5 wherein said second input source includes an audio input device.

7. The remote conferencing system according to claim 5 wherein said second input source includes a video input device.

8. The remote conferencing system according to claim 1 wherein said drawing medium comprises a dynamic graphical input device configured to detect drawings made on said drawing medium in near real-time.

9. The remote conferencing system according to claim 1 wherein said input device includes an image data compressor.

10. The remote conferencing system according to claim 1 wherein said input device includes a format converter configured to convert image data between two different image formats, at least one of said formats including one of raster, bitmapped, geometric, alphanumeric, Portable Network Graphics (PNG), Computer Graphics Metafile (CGM), Group 3 Facsimile, Graphics Interchange Format (GIF), JPEG File Interchange Format, Tag Image File Format (TIFF), MPEG and CCITT H.261 encoded image data.

11. A method of conducting a remote conference, comprising the steps of:
positioning a viewable medium to be viewed by a first plurality of conference participants;
receiving a first image from a remote location;
displaying a first image on a viewable medium;
writing a second image onto said viewable medium;
converting said second image into an electronic format;
combining said first and second images to form a composite image;
transmitting said composite image to said remote location; and
displaying said composite image to a second plurality of conference participants at said remote location.

12. The method according to claim 11 wherein said converting step includes optically scanning said second image to provide a digital image signal.

13. The method according to claim 11 further comprising the steps of:
manually writing, at said remote location, a third image onto composite image to form a new composite image;
transmitting said new composite image for viewing said first plurality of conference participants; and
displaying said new composite image to said first plurality of conference participants.

14. The method according to claim 11 wherein said converting step is responsive to a color of said first image for selectively processing said second image as one of text and graphics.
